(19) United States
(12) Patent Application Publication
(10) Pub. No.: US 2019/0343160 A1
(43) Pub. Date: Nov. 14, 2019

(54) NATURAL COMPOUND BIOPRESERVATIVE FOR SASHIMI

(71) Applicant: Zhejiang Ocean University, Zhoushan (CN)

(72) Inventors: Shanggui DENG, Zhoushan (CN); Wenhua MIAO, Zhoushan (CN); Quanming YANG, Zhoushan (CN)

(21) Appl. No.: 16/406,871

(22) Filed: May 8, 2019

(30) Foreign Application Priority Data
May 8, 2018 (CN) 201810431993.6

(51) Int. Cl. A23L 33/105

(52) U.S. Cl. CPC A23L 33/105

(57) ABSTRACT

A natural compound biopreservative for sashimi. The biopreservative is prepared from 20-30 parts by weight of a Fagopyrum tataricum extract, 10-15 parts by weight of an Osbeckia chinensis extract and 5-10 parts by weight of a mint extract. The preservative of the invention has good antibacterial and bactericidal performances and oxidation resistance, thereby maintaining the freshness and taste of the sashimi.

### CROSS-REFERENCE TO RELATED APPLICATIONS

This application claims the benefit of priority from Chinese Patent Application No. CN201810431993.6, filed on May 8, 2018. The content of the aforementioned application, including any intervening amendments thereto, is incorporated herein by reference in its entirety.

### TECHNICAL FIELD

The present application relates to preservatives, and more particularly to a natural compound biopreservative for sashimi.

### BACKGROUND

Food preservation is closely related to human health. Currently, most of the preservatives commonly used are chemicals such as sodium benzoate and potassium sorbate, which may cause potential harm to human health after excessive intake. After long-term researches, it has been found that some chemical preservatives may induce and cause the occurrence of cancers, and may also easily result in food poisoning. Therefore, there is a need for a novel biological preservative without toxic and side effects.

Recently, there are researches and applications focused on natural preservatives in the food industry because they are safe and non-toxic which is different than the synthetic preservatives. The natural preservatives are divided into three categories according to their sources, animal-derived biopreservatives, plant-derived biopreservatives, and microbial biopreservatives.

Sashimi is a dish consisting of fresh raw fishes or shellfishes sliced into pieces which is often consumed with condiments. If the fresh raw slices are excessive, bacteria may easily grow in the sashimi after overnight storage, thereby affecting the taste. For example, excess of raw seafood slices often happens in the cafeteria, resulting in food waste due to spoilage. In addition, moisture in the sashimi tends to evaporate, so that the freshness and taste of sashimi are reduced because of their exposure to oxygen. Some natural preservatives for aquatic products are commercially available, but their antibacterial ingredients are single and cannot maintain the moisture in the products, such that the aquatic products easily become odorous and smelly to affect the taste.

### SUMMARY

The present application provides a natural compound biopreservative that inhibits bacterial growth and prevents water evaporation so as to improve the freshness and taste of sashimi.

A natural compound biopreservative for sashimi is prepared from 20-30 parts by weight of a Fagopyrum tataricum extract, 10-15 parts by weight of an Osbeckia chinensis extract and 5-10 parts by weight of a mint extract.

In the invention, natural preservative ingredients are extracted from plants and will not cause harm to human health. The Fagopyrum tataricum extract comprises flavonoids such as rutin and resveratrol, and phenolic antioxidants such as proanthocyanidin. The flavonoids effectively inhibit and kill bacteria, preventing the sashimi from being rancid. When sashimi is exposed to air, it is prone to produce superoxide anion radicals and hydroxyl radicals, which cause oxidation of lipids and proteins in sashimi, leading to a poor taste.

The Fagopyrum tataricum extract containing phenolic antioxidants with strong antioxidative activity, for example proanthocyanidin, serves to eliminate free radicals and maintain the taste of sashimi by preventing the oxidation of lipids and proteins in sashimi.

The Osbeckia chinensis extract comprises gallic acid and zirconium methyl gallate, which can also effectively prevent the oxidation of lipids and proteins in sashimi so as to keep the good taste of sashimi. Carboxyl group in the gallic acid antioxidant forms an intermolecular hydrogen bond with the phenolic hydroxyl group in the resveratrol flavonoids. Therefore, the interaction between molecules is enhanced, enabling the antibacterial component (resveratrol) and the antioxidative component (gallic acid) to form stable dispersion in the preservative after dispersion to keep the sashimi fresh.

The mint extract can combine with flavonoids in the preservative to expand the antibacterial spectrum, further improving the killing and inhibitory effect on bacteria.

The Fagopyrum tataricum extract, the Osbeckia chinensis extract and the mint extract provide better water retention owing to hydrophilic groups, thus preventing the decrease in freshness of the sashimi. In addition, the Fagopyrum tataricum is also rich in selenium that is antioxidative, so that the antioxidative capability of the preservative is improved.

In an embodiment, the Fagopyrum tataricum extract is prepared by the following steps:

(1) drying Fagopyrum tataricum at 70-80° C. for 12-24 hours, and then pulverizing the dried Fagopyrum tataricum with a pulverizer followed by passing through a sieve of 20-30 mesh to obtain a Fagopyrum tataricum powder;

(2) adding 5-10 parts by weight of the Fagopyrum tataricum powder to 60-80 parts by weight of an ethanol solution followed by ultrasonic vibration at room temperature for 2-3 hours and filtration with a filter paper to obtain extract A;

(3) collecting the Fagopyrum tataricum powder remaining on a surface of the filter paper after filtration in step (2), extracting the remaining Fagopyrum tataricum powder by a supercritical carbon dioxide method through separation to obtain a solid Fagopyrum tataricum extract and a liquid extract, adding the solid Fagopyrum tataricum extract to 50-60 parts by weight of deionized water followed by heating under stirring for 2-3 hours and filtration to obtain a water-soluble extract, and mixing the water-soluble extract with the liquid extract to obtain extract B; and

(4) mixing extract A with extract B followed by concentration at 60-70° C. by a rotary evaporator to obtain the Fagopyrum tataricum extract.

The Fagopyrum tataricum extract contains the antioxidant components of flavonoid bactericidal and proanthocyanidin phenolic. Their contents vary with different extraction methods. In the invention, an ethanol solution is used to soak the Fagopyrum tataricum to obtain a higher content of flavonoid bactericidal component. Then the soaked Fagopyrum tataricum is extracted by a supercritical carbon dioxide method to obtain a higher content of proanthocyanidin phenolic antioxidant component. The two components are mixed and concentrated to obtain a higher content of bactericidal antioxidant component. In the invention, the flavonoid bactericidal component and the proanthocyanidin phenolic antioxidant component are separately extracted from the same plant, so that the raw material is fully utilized which has the advantages of economical materials and reduced costs.

In an embodiment, in step (2), a mass fraction of the ethanol solution is 40%-50%.

In an embodiment, in step (3), the heating under stirring is performed at 80-90° C.

In an embodiment, the Osbeckia chinensis extract is prepared by the following steps:

drying Osbeckia chinensis at 50-60° C. for 10-20 hours, and then pulverizing the dried Osbeckia chinensis with a pulverizer followed by passing through a sieve of 20-30 mesh to obtain an Osbeckia chinensis powder; and

adding 2-3 parts by weight of the Osbeckia chinensis powder to 50-60 parts by weight of an ethanol solution followed by ultrasonic vibration at room temperature for 3-5 hours and filtration with a filter paper to obtain an extract, and concentrating the extract at 50-60° C. by a rotary evaporator to obtain the Osbeckia chinensis extract.

In an embodiment, a mass fraction of the ethanol solution is 30%-40%.

In an embodiment, the mint extract is prepared by the following steps:

drying a mint at 60-70° C. for 10-20 hours, and then pulverizing the dried mint with a pulverizer followed by passing through a sieve of 20-30 mesh to obtain a mint powder; and

adding 3-5 parts by weight of the mint powder to 70-80 parts by weight of an ethanol solution followed by ultrasonic vibration at room temperature for 2-4 hours and filtration with a filter paper to obtain an extract, and concentrating the extract at 60-70° C. by a rotary evaporator to obtain the mint extract.

In an embodiment, a mass fraction of the ethanol solution is 35%-40%.

A method of preparing the natural compound biological preservative for sashimi comprises:

pulverizing the Fagopyrum tataricum extract, the Osbeckia chinensis extract and the mint extract separately in a weight ratio, and then mixing the pulverized extracts to obtain the natural compound biological preservative.

The present invention has the following beneficial effects.

(1) The invention shows a good bactericidal and antibacterial effect to prevent the sashimi from being rancid.

(2) The proanthocyanidin phenolic antioxidant component can prevent the oxidation of lipids and proteins in sashimi to keep the taste.

(3) The bactericidal and antioxidant components show good dispersion stability to keep the sashimi fresh.

(4) The invention has good water retention.

### DETAILED DESCRIPTION OF EMBODIMENTS

The present invention will be further described below with reference to embodiments.

Unless otherwise specified, the raw materials and equipments used herein are commercially available or commonly used in the art, and methods used in the embodiments are conventional methods in the art.

### EXAMPLE 1

A natural compound biological preservative for sashimi was prepared from 20 parts by weight of a Fagopyrum tataricum extract, 10 parts by weight of an Osbeckia chinensis extract and 5 parts by weight of a mint extract.

The Fagopyrum tataricum extract was prepared as follows.

(1) Fagopyrum tataricum was dried at 70° C. for 12 hours and then pulverized with a pulverizer. The pulverized Fagopyrum tataricum was passed through a sieve of 20 mesh to obtain a Fagopyrum tataricum powder.

(2) 5 parts by weight of the Fagopyrum tataricum powder was added to 60 parts by weight of an ethanol solution with a mass fraction of 40% which were subjected to ultrasonic vibration at room temperature for 2-3 hours and then filtered with a filter paper to produce extract A.

(3) The Fagopyrum tataricum powder remaining on surface of the filter paper after filtration in step (2) was collected and extracted by a supercritical carbon dioxide method through separation to obtain a solid Fagopyrum tataricum extract and a liquid extract. The solid Fagopyrum tataricum extract was added to 50 parts by weight of deionized water, heated at 80° C. under stirring for 2 hours and filtered to obtain a water-soluble extract. The water-soluble extract was mixed with the liquid extract to obtain extract B.

(4) The extract A was mixed with the extract B and then concentrated at 60° C. by a rotary evaporator to obtain the Fagopyrum tataricum extract.

The Osbeckia chinensis extract was prepared as follows.

Osbeckia chinensis was dried at 50° C. for 10 hours, and then pulverized with a pulverizer. The pulverized Osbeckia chinensis was passed through a sieve of 20 mesh to obtain an Osbeckia chinensis powder.

2 parts by weight of the Osbeckia chinensis powder was added to 50 parts by weight of an ethanol solution with a mass fraction of 30%, which were subjected to ultrasonic vibration at room temperature for 3 hours and then filtered with a filter paper to obtain an extract. The extract was concentrated at 50° C. by a rotary evaporator to obtain the Osbeckia chinensis extract.

The mint extract was prepared as follows.

A mint was dried at 60° C. for 10 hours and then pulverized with a pulverizer. The pulverized mint was passed through a sieve of 20 mesh to obtain a mint powder.

3 parts by weight of the mint powder was added to 70 parts by weight of an ethanol solution with a mass fraction of 35%, which were subjected to ultrasonic vibration at room temperature for 2 hours and then filtered with a filter paper to obtain an extract. The extract was concentrated at 60° C. by a rotary evaporator to obtain the mint extract.

### EXAMPLE 2

A natural compound biopreservative for sashimi was prepared from 22 parts by weight of a Fagopyrum tataricum extract, 12 parts by weight of an Osbeckia chinensis extract and 6 parts by weight of a mint extract.

The Fagopyrum tataricum extract was prepared as follows.

(1) Fagopyrum tataricum was dried at 72° C. for 15 hours and then pulverized with a pulverizer. The pulverized Fagopyrum tataricum was passed through a sieve of 23 mesh to obtain a Fagopyrum tataricum powder.

(2) 6 parts by weight of the Fagopyrum tataricum powder was added into 65 parts by weight of an ethanol solution with a mass fraction of 45%, which were subjected to ultrasonic vibration at room temperature for 2.2 hours and filtered with a filter paper to produce extract A.

(3) The Fagopyrum tataricum powder remaining on surface of the filter paper after filtration in step (2) was collected and extracted by a supercritical carbon dioxide method through separation to obtain a solid Fagopyrum tataricum extract and a liquid extract. The solid Fagopyrum tataricum extract was added to 53 parts by weight of deionized water, heated at 85° C. under stirring for 2.3 hours and filtered to obtain a water-soluble extract. The water-soluble extract was mixed with the liquid extract to obtain extract B.

(4) The extract A was mixed with the extract B and concentrated at 62° C. by a rotary evaporator to obtain the Fagopyrum tataricum extract.

The Osbeckia chinensis extract was prepared as follows.

Osbeckia chinensis was dried at 55° C. for 15 hours, and then pulverized with a pulverizer. The pulverized Osbeckia chinensis was passed through a sieve of 20 mesh to obtain an Osbeckia chinensis powder.

2.2 parts by weight of the Osbeckia chinensis powder was added to 55 parts by weight of an ethanol solution with a mass fraction of 30%, which were subjected to ultrasonic vibration at room temperature for 3.5 hours and then filtered with a filter paper to obtain an extract. The extract was concentrated at 52° C. by a rotary evaporator to obtain the Osbeckia chinensis extract.

The mint extract was prepared as follows.

Mint was dried at 65° C. for 12 hours and then pulverized with a pulverizer. The pulverized mint was passed through a sieve of 20 mesh to obtain a mint powder.

3.5 parts by weight of the mint powder was added into 73 parts by weight of an ethanol solution with a mass fraction of 35%, which were subjected to ultrasonic vibration at room temperature for 2.5 hours and then filtered with a filter paper to obtain an extract. The extract was concentrated at 62° C. by a rotary evaporator to obtain the mint extract.

### EXAMPLE 3

A natural compound biopreservative for sashimi was prepared from 25 parts by weight of a Fagopyrum tataricum extract, 13 parts by weight of an Osbeckia chinensis extract and 8 parts by weight of a mint extract.

The Fagopyrum tataricum extract was prepared as follows.

(1) Fagopyrum tataricum was dried at 73° C. for 16 hours and then pulverized with a pulverizer. The pulverized Fagopyrum tataricum was passed through a sieve of 25 mesh to obtain a Fagopyrum tataricum powder.

(2) 7 parts by weight of the Fagopyrum tataricum powder was added to 70 parts by weight of an ethanol solution with a mass fraction of 46%, which were subjected to ultrasonic vibration at room temperature for 2.5 hours and then filtered with a filter paper to produce extract A.

(3) The Fagopyrum tataricum powder remaining on surface of the filter paper after filtration in step (2) was collected and extracted by a supercritical carbon dioxide method through separation to obtain a solid Fagopyrum tataricum extract and a liquid extract. The solid Fagopyrum tataricum extract was added to 55 parts by weight of deionized water, heated at 86° C. under stirring for 2.4 hours and filtered to obtain a water-soluble extract. The water-soluble extract was mixed with the liquid extract to obtain extract B.

(4) The extract A was mixed with the extract B, and concentrated at 63° C. by a rotary evaporator to obtain the Fagopyrum tataricum extract.

The Osbeckia chinensis extract was prepared as follows.

Osbeckia chinensis was dried at 56° C. for 16 hours, and then pulverized with a pulverizer. The pulverized Osbeckia chinensis was passed through a sieve of 30 mesh to obtain an Osbeckia chinensis powder.

2.5 parts by weight of the Osbeckia chinensis powder was added to 56 parts by weight of an ethanol solution with a mass fraction of 35%, which were subjected to ultrasonic vibration at room temperature for 4 hours and filtered with a filter paper to obtain an extract. The extract was concentrated at 53° C. by a rotary evaporator to obtain the Osbeckia chinensis extract.

The mint extract was prepared as follows.

Mint was dried at 66° C. for 13 hours and then pulverized with a pulverizer. The pulverized mint was passed through a sieve of 20 mesh to obtain a mint powder.

4 parts by weight of the mint powder was added into 75 parts by weight of an ethanol solution with a mass fraction of 40%, which were subjected to ultrasonic vibration at room temperature for 3 hours and then filtered with a filter paper to obtain an extract. The extract was concentrated at 65° C. by a rotary evaporator to obtain the mint extract.

### EXAMPLE 4

A natural compound biopreservative for sashimi was prepared from 27 parts by weight of a Fagopyrum tataricum extract, 14 parts by weight of an Osbeckia chinensis extract and 9 parts by weight of a mint extract.

The Fagopyrum tataricum extract was prepared as follows.

(1) Fagopyrum tataricum was dried at 75° C. for 20 hours and then pulverized with a pulverizer. The pulverized Fagopyrum tataricum was passed through a sieve of 27 mesh to obtain a Fagopyrum tataricum powder.

(2) 8 parts by weight of the Fagopyrum tataricum powder was added into 75 parts by weight of an ethanol solution with a mass fraction of 48%, which were subjected to ultrasonic vibration at room temperature for 2.8 hours and then filtered with a filter paper to produce extract A.

(3) The Fagopyrum tataricum powder remaining on surface of the filter paper after filtration in step (2) was collected and extracted by a supercritical carbon dioxide method through separation to obtain a solid Fagopyrum tataricum extract and a liquid extract. The solid Fagopyrum tataricum extract was added to 58 parts by weight of deionized water, heated at 88° C. under stirring for 2.5 hours and filtered to obtain a water-soluble extract. The water-soluble extract was mixed with the liquid extract to obtain extract B.

(4) The extract A was mixed with the extract B, and concentrated at 65° C. by a rotary evaporator to obtain the Fagopyrum tataricum extract.

The Osbeckia chinensis extract was prepared as follows.

Osbeckia chinensis was dried at 58° C. for 17 hours, and then pulverized with a pulverizer. The pulverized Osbeckia chinensis was passed through a sieve of 30 mesh to obtain an Osbeckia chinensis powder.

2.8 parts by weight of the Osbeckia chinensis powder was added to 58 parts by weight of an ethanol solution with a mass fraction of 40%, which were subjected to ultrasonic vibration at room temperature for 4.5 hours and then filtered with a filter paper to obtain an extract. The extract was concentrated at 55° C. by a rotary evaporator to obtain the Osbeckia chinensis extract.

The mint extract was prepared as follows.

Mint was dried at 68° C. for 15 hours and then pulverized with a pulverizer. The pulverized mint was passed through a sieve of 30 mesh to obtain a mint powder.

4.5 parts by weight of the mint powder was added into 77 parts by weight of an ethanol solution with a mass fraction of 40%, which were subjected to ultrasonic vibration at room temperature for 3.5 hours and then filtered with a filter paper to obtain an extract. The extract was concentrated at 68° C. by a rotary evaporator to obtain the mint extract.

### EXAMPLE 5

A natural compound biopreservative for sashimi was prepared from 30 parts by weight of a Fagopyrum tataricum extract, 15 parts by weight of an Osbeckia chinensis extract and 10 parts by weight of a mint extract.

The Fagopyrum tataricum extract was prepared as follows.

(1) Fagopyrum tataricum was dried at 80° C. for 24 hours and then pulverized with a pulverizer. The pulverized Fagopyrum tataricum was passed through a sieve of 30 mesh to obtain a Fagopyrum tataricum powder.

(2) 10 parts by weight of the Fagopyrum tataricum powder was added to 80 parts by weight of an ethanol solution with a mass fraction of 50%, which were subjected to ultrasonic vibration at room temperature for 3 hours and then filtered with a filter paper to produce extract A.

(3) The Fagopyrum tataricum powder remaining on surface of the filter paper after filtration in step (2) was collected and extracted by a supercritical carbon dioxide method through separation to obtain a solid Fagopyrum tataricum extract and a liquid extract. The solid Fagopyrum tataricum extract was added to 60 parts by weight of deionized water, heated at 90° C. under stirring for 3 hours and filtered to obtain a water-soluble extract. The water-soluble extract was mixed with the liquid extract to obtain extract B.

(4) The extract A was mixed with the extract B and then concentrated at 70° C. by a rotary evaporator to obtain the Fagopyrum tataricum extract.

The Osbeckia chinensis extract was prepared as follows.

Osbeckia chinensis was dried at 60° C. for 20 hours, and then pulverized with a pulverizer. The pulverized Osbeckia chinensis was passed through a sieve of 30 mesh to obtain an Osbeckia chinensis powder.

3 parts by weight of the Osbeckia chinensis powder was added to 60 parts by weight of an ethanol solution with a mass fraction of 40%, which were subjected to ultrasonic vibration at room temperature for 5 hours and then filtered with a filter paper to obtain an extract. The extract was concentrated at 60° C. by a rotary evaporator to obtain the Osbeckia chinensis extract.

The mint extract was prepared as follows.

Mint was dried at 70° C. for 20 hours and then pulverized with a pulverizer. The pulverized mint was passed through a sieve of 30 mesh to obtain a mint powder.

5 parts by weight of the mint powder was added to 80 parts by weight of an ethanol solution with a mass fraction of 40%, which were subjected to ultrasonic vibration at room temperature for 4 hours and then filtered with a filter paper to obtain an extract. The extract was concentrated at 70° C. by a rotary evaporator to obtain the mint extract.

The natural compound biopreservatives prepared in Examples 1-5 were tested for antibacterial properties by the filter paper method and the dilution plate colony counting method. The results were shown in Table 1.

TABLE 1
Inhibition zones of natural preservatives
against different microorganisms (Unit: mm)

| | E. | Staphylococcus | Pseudomonas | Bacillus | Candida |
|---|---|---|---|---|---|
| | coli | aureus | fluorescens | subtilis | utilis |
| Example 1 | 12.3 | 13.2 | 8.8 | 12.6 | 8.6 |
| Example 2 | 10.4 | 12.6 | 9.5 | 10.5 | 10.7 |
| Example 3 | 10.8 | 13.5 | 7.6 | 9.8 | 8.1 |
| Example 4 | 11.6 | 10.8 | 8.2 | 11.6 | 10.4 |
| Example 5 | 10.2 | 11.6 | 6.4 | 9.2 | 9.5 |

It can be seen from the inhibition zone results that the natural compound biopreservative of the invention has good antibacterial effect.

The above embodiments are merely illustrative of the invention and are not intended to limit the scope of the invention. Any equivalent variations or modifications made by those skilled in the art without departing from the spirit of the invention should still fall within the scope of the invention.

What is claimed is:

1. A natural compound biopreservative for sashimi, wherein the biopreservative is prepared from 20-30 parts by weight of a Fagopyrum tataricum extract, 10-15 parts by weight of an Osbeckia chinensis extract and 5-10 parts by weight of a mint extract.

2. The natural compound biopreservative of claim 1, wherein the Fagopyrum tataricum extract is prepared by the following steps:
(1) drying Fagopyrum tataricum at 70-80° C. for 12-24 hours, and then pulverizing the dried Fagopyrum tataricum by a pulverizer followed by passing through a sieve of 20-30 mesh to obtain a Fagopyrum tataricum powder;
(2) adding 5-10 parts by weight of the Fagopyrum tataricum powder to 60-80 parts by weight of an ethanol solution followed by ultrasonic vibration at room temperature for 2-3 hours and filtration with a filter paper to obtain extract A;
(3) collecting the Fagopyrum tataricum powder remaining on a surface of the filter paper after filtration in step (2), extracting the remaining Fagopyrum tataricum powder by a supercritical carbon dioxide method through separation to obtain a solid Fagopyrum tataricum extract and a liquid extract; adding the solid Fagopyrum tataricum extract to 50-60 parts by weight of deionized water followed by heating under stirring for 2-3 hours and filtration to obtain a water-soluble extract, and mixing the water-soluble extract with the liquid extract to obtain extract B; and
(4) mixing extract A with extract B followed by concentration at 60-70° C. by a rotary evaporator to obtain the Fagopyrum tataricum extract.

3. The natural compound biopreservative of claim 2, wherein in step (2), a mass fraction of the ethanol solution is 40%-50%.

4. The natural compound biopreservative of claim 2, wherein in step (3), the heating under stirring is performed at 80-90° C.

5. The natural compound biopreservative of claim 1, wherein the Osbeckia chinensis extract is prepared by the following steps:
drying Osbeckia chinensis at 50-60° C. for 10-20 hours, and then pulverizing the dried Osbeckia chinensis with a pulverizer followed by passing through a sieve of 20-30 mesh to obtain an Osbeckia chinensis powder; and
adding 2-3 parts by weight of the Osbeckia chinensis powder to 50-60 parts by weight of an ethanol solution followed by ultrasonic vibration at room temperature for 3-5 hours and filtration with a filter paper to obtain an extract, and concentrating the extract at 50-60° C. by a rotary evaporator to obtain the Osbeckia chinensis extract.

6. The natural compound biopreservative of claim 5, wherein a mass fraction of the ethanol solution is 30%-40%.

7. The natural compound biopreservative of claim 1, wherein the mint extract is prepared by the following steps:
drying a mint at 60-70° C. for 10-20 hours, and then pulverizing the dried mint with a pulverizer followed by passing through a sieve of 20-30 mesh to obtain a mint powder; and
adding 3-5 parts by weight of the mint powder to 70-80 parts by weight of an ethanol solution followed by ultrasonic vibration at room temperature for 2-4 hours and filtration with a filter paper to obtain an extract, and concentrating the extract at 60-70° C. by a rotary evaporator to obtain the mint extract.

8. The natural compound biopreservative of claim 7, wherein a mass fraction of the ethanol solution is 35%-40%.
